(19) United States
(12) Patent Application Publication
(10) Pub. No.: US 2016/0237321 A1
(43) Pub. Date: Aug. 18, 2016

(54) POLYETHYLENE TAPE

(71) Applicant: Ling-Cheng Chen, Taipei City (TW)

(72) Inventor: Ling-Cheng Chen, Taipei City (TW)

(21) Appl. No.: 14/686,568

(22) Filed: Apr. 14, 2015

(30) Foreign Application Priority Data
Feb. 13, 2015 (TW) 104105116

(51) Int. Cl. C09J 7/02; B32B 27/32; B32B 27/08

(52) U.S. Cl. CPC C09J 7/0296; B32B 27/08; B32B 27/32; C09J 7/0275; C09J 7/0246; C09J 7/0253; B32B 2307/402; B32B 2307/412; B32B 2405/00; C09J 2201/122; C09J 2201/606; C09J 2433/00; C09J 2201/162; C09J 2423/046

(57) ABSTRACT

A polyethylene tape including a first backing layer, a second backing layer, a third backing layer, and an adhesive layer in sequence. The first and the third backing layers are transparent polyethylene films which sandwich the second backing layer therebetween. The second backing layer is a colored polyethylene film. The adhesive layer is acrylic glue coated on the third backing layer. The first and the third backing layers isolate the second backing layer from the adhesive layer even if the polyethylene tape is reeled up into a roll.

### BACKGROUND OF THE INVENTION

1. Technical Field

The present invention relates generally to a tape to be attached to an object for protection or fixing, and more particularly to a structure of a polyethylene tape.

2. Description of Related Art

As the improvement of industrial technology, adhesive tapes are widely used in ordinary and engineering fields. Typically, the conventional tapes are made of polyvinylchloride (PVC), which is cheaper and easy to be manufactured.

The conventional PVC tape is reeled up into a roll for sale. For a roll of the PVC tape, the adhesive side of the tape is stuck on the back side of the tape, and the leaves some adhesive on the back side of the tape after a user pulled the tape out of the roll. This residual adhesive on the back side of the tape gives some bad effect on the use of the PVC tape, such as transfer to user's hand.

Another problem of the conventional PVC tape is that plasticizer will come out from the backing material when the PVC tape is put in a high-temperature environment or in a large temperature-difference environment. It results some problems, such as sticky on the cross-sectional surface, adhesive flow, shifting of the tape in the roll, and poor anti-aging capacity. In other words, the conventional PVC tape has several drawbacks, such as not good for the user to operate it, clearing problem, and poor durability.

In recent days, the development of environmentally friendly materials, so called eco-materials, is proceeding in many countries. In 2004, European Union rejected any electrical device or industrial product containing lead and halogen. Therefore, it needs an alternated material to replace the PVC tape, which contains chloride.

Some manufactures of the tapes starts to develop the backing material of the tape of single-layered polyethylene (PE) to fix the problems of above.

However, when the PE tape is printed with texts or icons or colored, the ink will have an affinity with the adhesive on the tape. As a result, the ink will transfer to the adhesive and make the adhesive be colored or printed with texts or icons.

In conclusion, the conventional PE tape still needs to be improved.

### BRIEF SUMMARY OF THE INVENTION

The primary objective of the present disclosure directs to a polyethylene tape, which has no drawback as described above.

In order to achieve the objective of the present invention, the polyethylene tape of the present invention includes a first backing layer, which is made of polyethylene, and is transparent; a second backing layer, which is made of polyethylene, and is colored, wherein the second backing layer is attached to the first backing layer; a third backing layer, which is made of polyethylene, and is transparent, wherein the third backing layer is attached to the second backing layer, so that the second backing layer is between the first backing layer and the third backing layer; and an adhesive layer, which is acrylic glue, attached to the third backing layer, wherein the third backing layer is between the adhesive layer and the second backing layer.

In an embodiment, the polyethylene tape further includes an ink layer on the first backing layer, wherein the first backing layer is between the ink layer and the second backing layer, and a color of the ink layer is different from that of the second backing layer.

In an embodiment, the polyethylene tape further includes an antistatic layer and a release layer, wherein the antistatic layer is made of a conductive material, and is attached to the ink layer, so that the ink layer is between the first backing layer and the antistatic layer; the release layer contains a release agent, and is attached to the antistatic layer, so that the antistatic layer is between the release layer and the ink layer.

In an embodiment, the polyethylene tape further includes a release layer, wherein the release layer contains a release agent, and is attached to the ink layer, so that the ink layer is between the release layer and the first backing layer.

In an embodiment, the polyethylene tape further includes an antistatic layer and a release layer, wherein the antistatic layer is made of a conductive material, and is attached to the first backing layer, so that the first backing layer is between the second backing layer and the antistatic layer; the release layer contains a release agent, and is attached to the antistatic layer, so that the antistatic layer is between the release layer and the first backing layer.

In an embodiment, the polyethylene tape further includes a release layer, wherein the release layer contains a release agent, and is attached to the first backing layer, so that the first backing layer is between the release layer and the second backing layer.

No matter the polyethylene tape is reeled up into a roll or not, the first and the third backing layers may isolate the second backing layer from the adhesive layer to avoid the drawbacks of the conventional PVC tape.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is an exploded view of a first preferred embodiment of the present invention;

FIG. 2 is a perspective view of the first preferred embodiment of the present invention, showing the roll of the polyethylene tape;

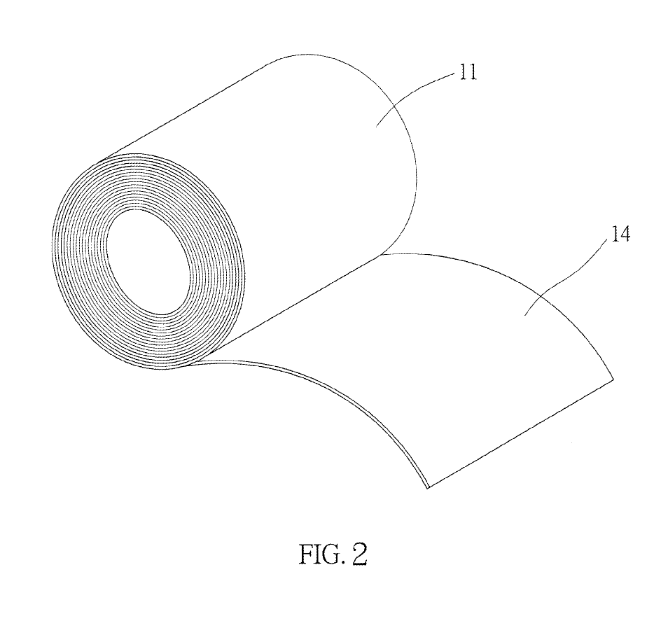

FIG. 3 is an exploded view of a second preferred embodiment of the present invention;

FIG. 4 is an exploded view of a third preferred embodiment of the present invention;

FIG. 5 is an exploded view of a fourth preferred embodiment of the present invention;

FIG. 6 is an exploded view of a fifth preferred embodiment of the present invention; and

FIG. 7 is an exploded view of a sixth preferred embodiment of the present invention.

### DETAILED DESCRIPTION OF THE INVENTION

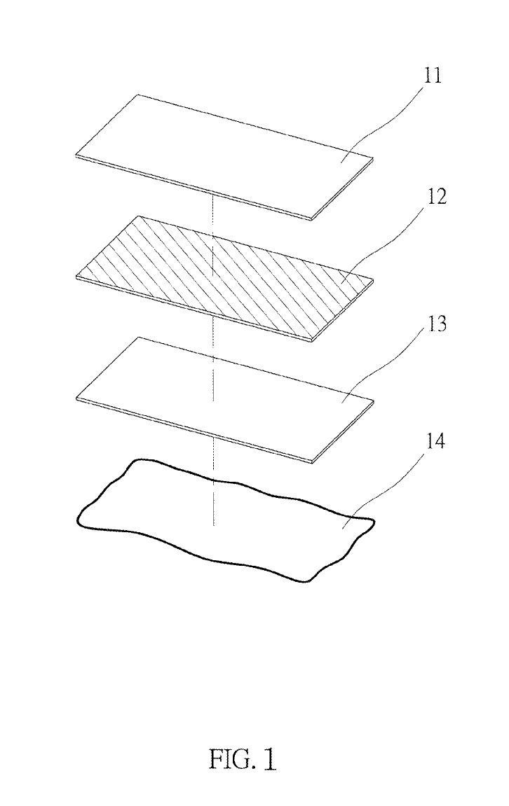

As shown in FIG. 1, a polyethylene tape of the first preferred embodiment of the present invention includes a first backing layer 11, a second backing layer 12, a third backing layer 13, and an adhesive layer 14.

The first backing layer 11 is a polyethylene (PE) film, and is made by injection molding. The first backing layer 11 is transparent, and is not colored. The reason of why the first backing layer 11 is made of PE is that PE lacks an odor and nontoxic, and furthermore, PE is stable in low temperature, and has a superior performance in chemical stability and acid/alkali resistance. Moreover, PE will be brittle after exposure under the sun for a long time, and generate CO₂ and H₂O after burning. In other words, PE generates less pollution, and is recyclable.

The second backing layer 12 is a polyethylene (PE) film as well, and is bonded to the first backing layer 11 by injection molding. The second backing layer 12 is colored by a recyclable white dye. Except white, the second backing layer 12 can be any color, such as black, red, and yellow, to facilitate identification.

The third backing layer 13 is a polyethylene (PE) film as well, and is bonded to the second backing layer 12 by injection molding. As a result, the second backing layer 12 is sandwiched by the first and the third backing layers 11, 13. The third backing layer 13, the same as the first backing layer 11, is transparent, and is not colored.

The adhesive layer 14 is recyclable acrylic glue coated on an exterior side of the third backing layer 13. In other words, the third backing layer 13 is between the second backing layer 12 and the adhesive layer 14. A thickness of the adhesive layer 14 is less than a sum of thicknesses of the first, the second, and the third backing layers 11, 12, 13, and more preferable, the thickness of the adhesive layer 14 is less than the thicknesses of the first, the second, and the third backing layers 11, 12, 13 respectively. The reason of selecting recyclable acrylic glue is that acrylic glue has no solvent, and has a high affiliation with PE. With the thickness limitation of above, the adhesive layer 14 is firmly bonded to the third backing layer 13 without the adhesive flow problem.

As a result, the third backing layer 13 isolates the second backing layer 12 from the adhesive layer 14 to avoid affiliation of the dye in the second backing layer 12 and the adhesive layer 14. Besides, when the PE tape is reeled up into a roll, the adhesive layer 14 is attached to the first backing layer 11. In this condition, the second backing layer 12 and the adhesive layer 14 are isolated by the first backing layer 11, and the same function will arise to avoid affiliation of the dye in the second backing layer 12 and the adhesive layer 14. Both the first and the third backing layers 11, 13 are transparent which may show the color of the second backing layer 12.

When the PE tape of the first preferred embodiment of the present invention is attached to an object, such as an aluminum window frame, the adhesive layer 14 will be not left on the object if the PE tape is torn off.

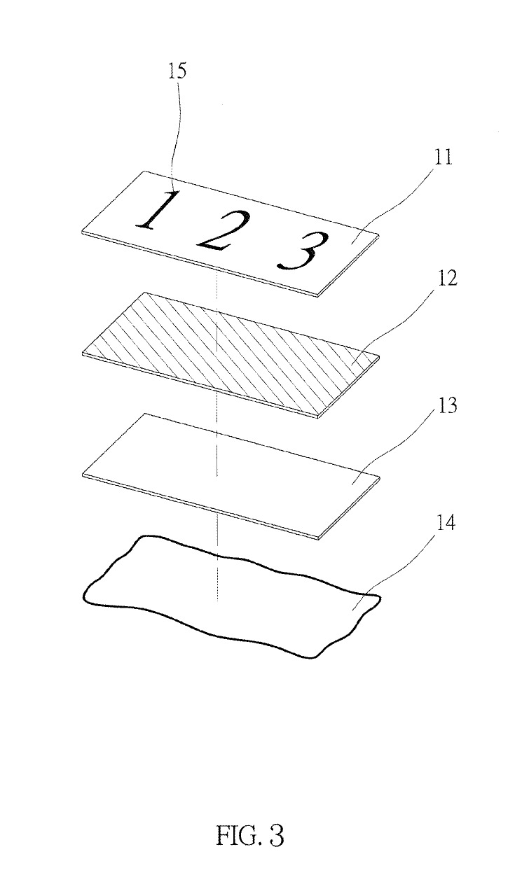

As shown in FIG. 3, a PE tape of the second preferred embodiment of the present invention, which is based on the first preferred embodiment, includes a first backing layer 11, a second backing layer 12, a third backing layer 13, and an adhesive layer 14. The PE tape of the second preferred embodiment further is printed with an ink layer 15 on an exterior side of the first backing layer 11. The ink layer 15 is made of a recycle material, and the first backing layer 11 is between the first second backing layer 12 and the ink layer 15. The ink layer 15 could texts, icons, warnings, and brand names for labeling, warning, and adverting. In the second preferred embodiment, the ink layer 15 has blue texts, and preferable, the color of the ink layer 15 is different from the color of the second backing layer 12.

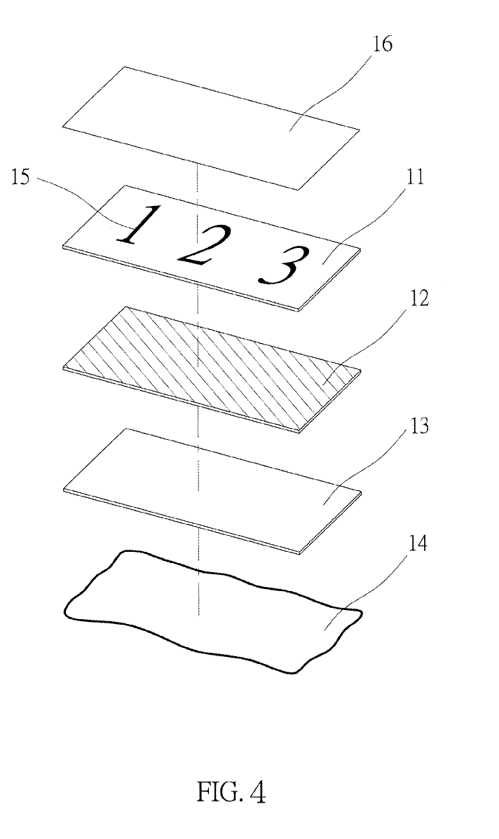

FIG. 4 shows a PE tape of the third preferred embodiment of the present invention, which is based on the second preferred embodiment, including a first backing layer 11, a second backing layer 12, a third backing layer 13, an adhesive layer 14, and an ink layer 15. Except that, the PE tape of the third preferred embodiment further includes a release layer 16. The release layer 16, which contains a release agent, is attached to the exterior side of the first backing layer 11 to cover the ink layer 15, and therefore the ink layer 15 is sandwiched by the first backing layer 11 and the release layer 16. The release layer 16 may be made of polyethylenimine (PEI), polyethylene terephthalate (PET), silicon oil, silicon rubber, or any material having a low affiliation with the adhesive layer 14.

When the PE tape is reeled up into a roll, the adhesive layer 14 is attached to the release layer 16 instead of the ink layer 15. It could prevent the ink layer 15 from transferring to the adhesive layer 14. In addition, the adhesive layer 14 will not left on the release layer 16 because of the low affiliation property while the PE tape is pulled out from the roll. It could keep the adhesion of the adhesive layer 14 as well as provide a good usage to the user.

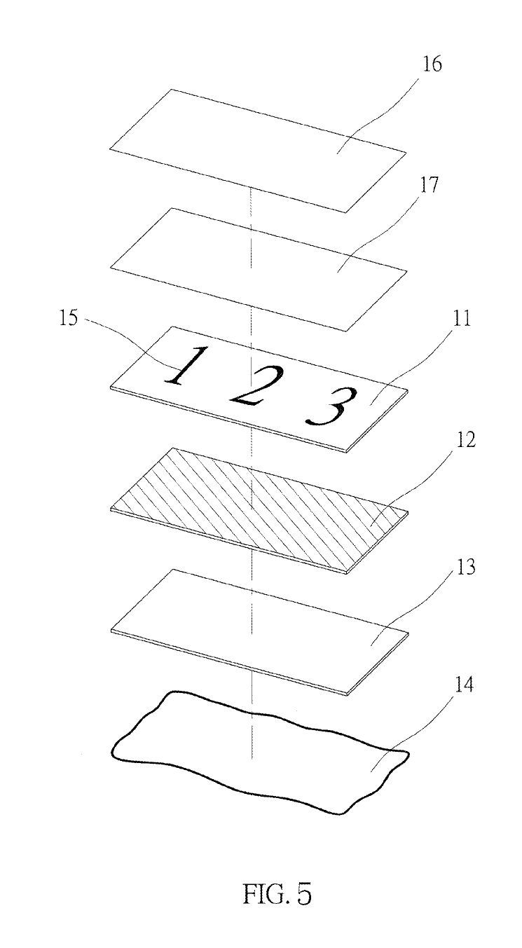

FIG. 5 shows a PE tape of the fourth preferred embodiment of the present invention, which is based on the third preferred embodiment, including a first backing layer 11, a second backing layer 12, a third backing layer 13, an adhesive layer 14, an ink layer 15, and a release layer 16. Except that, the PE tape of the third preferred embodiment further includes an antistatic layer 17 between the ink layer 15 and the release layer 16. In the present embodiment, the antistatic layer 17 is made of a conductive material, such as polythiophene (PT), carbon nanotube (CNT), and grapheme. The antistatic layer 17 may eliminate electrostatics on the release layer 16 to keep the function of the release layer 16.

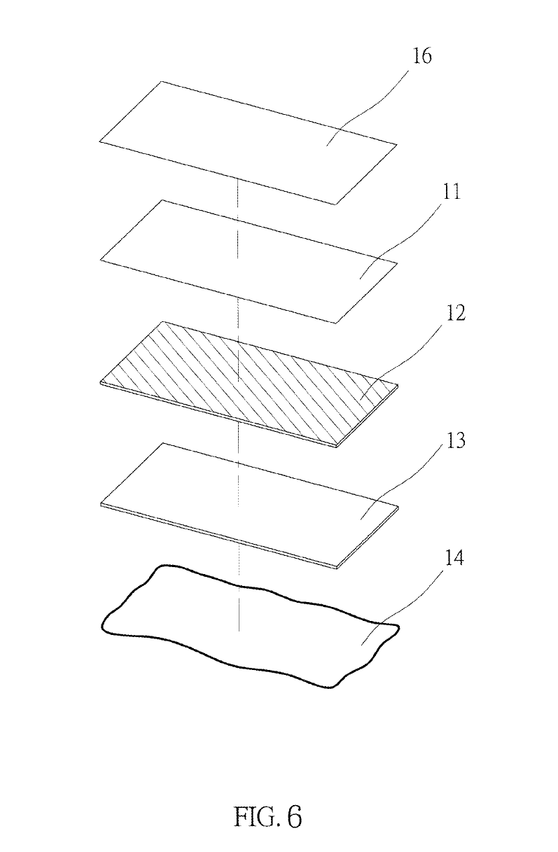

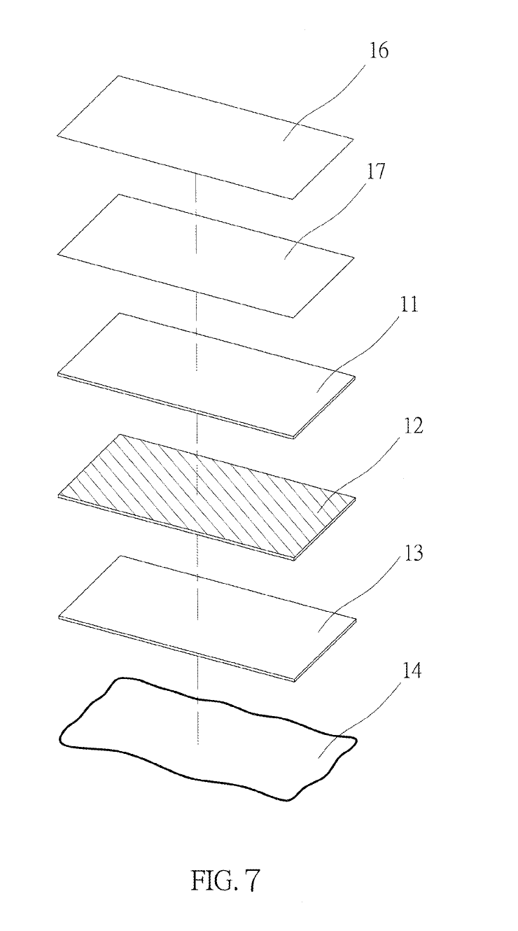

FIG. 6 shows a PE tape of the fifth preferred embodiment of the present invention, including a first backing layer 11, a second backing layer 12, a third backing layer 13, an adhesive layer 14, and a release layer 16. The first backing layer 11 of the fifth preferred embodiment is not printed with the ink layer, so that the first backing layer 11 is between the second backing layer 12 and the release layer 16. FIG. 7 shows a PE tape of the sixth preferred embodiment of the present invention, including a first backing layer 11, a second backing layer 12, a third backing layer 13, an adhesive layer 14, a release layer 16, and an antistatic layer 17. The antistatic layer 17 is attached to the first backing layer 11, and then the release layer 16 is attached to the antistatic layer 17, so that the antistatic layer 17 is between the first backing layer 11 and the release layer 16. It may avoid the problems of adhesive flow and residual adhesive. It also may avoid the dye from transferring to the adhesive layer 14.

Moreover, the PE tapes of above preferred embodiments could be further provided with a release sheet (not shown) attached to the adhesive layer 14, so that the adhesive layer 14 is between the third backing layer 13 and the release sheet. The release sheet gives the adhesive layer 14 a further protection.

In conclusion, the PE tape of the present invention is recyclable, and has no drawback of the conventional PVC tape. It must be pointed out that the embodiments described above are only some preferred embodiments of the present invention. All equivalent structures which employ the concepts disclosed in this specification and the appended claims should fall within the scope of the present invention.

1. A polyethylene tape, comprising:
a first backing layer, which is made of polyethylene and is transparent;
a second backing layer, which is made of polyethylene and includes a dye, wherein the second backing layer is attached to the first backing layer;
a third backing layer, which is made of polyethylene and is transparent, wherein the third backing layer is attached to the second backing layer, so that the second backing layer is between the first backing layer and the third backing layer; and
an adhesive layer, which is acrylic glue coated on the third backing layer, wherein the third backing layer is between the adhesive layer and the second backing layer such that the third backing layer isolates the second backing layer from the adhesive layer to avoid affiliation of the dye in the second backing layer with the adhesive layer.

2. The polyethylene tape of claim 1, further comprising an ink layer on the first backing layer, wherein the first backing layer is between the ink layer and the second backing layer, and a color of the ink layer is different from that of the second backing layer.

3. The polyethylene tape of claim 2, further comprising an antistatic layer and a release layer, wherein the antistatic layer is made of a conductive material and is attached to the ink layer, so that the ink layer is between the first backing layer and the antistatic layer; the release layer contains a release agent and is attached to the antistatic layer, so that the antistatic layer is between the release layer and the ink layer.

4. The polyethylene tape of claim 2, further comprising a release layer, wherein the release layer contains a release agent and is attached to the ink layer, so that the ink layer is between the release layer and the first backing layer.

5. The polyethylene tape of claim 1, further comprising an antistatic layer and a release layer, wherein the antistatic layer is made of a conductive material and is attached to the first backing layer, so that the first backing layer is between the second backing layer and the antistatic layer; the release layer contains a release agent and is attached to the antistatic layer, so that the antistatic layer is between the release layer and the first backing layer.

6. The polyethylene tape of claim 1, further comprising a release layer, wherein the release layer contains a release agent and is attached to the first backing layer, so that the first backing layer is between the release layer and the second backing layer.

7. The polyethylene tape of claim 1, wherein a thickness of the adhesive layer is less than a sum of thicknesses of the first backing layer, the second backing layer, and the third backing layer.

8. The polyethylene tape of claim 1, a thickness of the adhesive layer is less than that of the first backing layer, the second backing layer, and the third backing layer respectively.

9. The polyethylene tape of claim 1, further comprising a release sheet attached to the adhesive layer, wherein the adhesive layer is between the first backing layer and the release sheet.
